(19) United States
(12) Patent Application Publication
(10) Pub. No.: US 2015/0095013 A1
(43) Pub. Date: Apr. 2, 2015

(54) Extending Concept Labels of an Ontology

(71) Applicants: Sonja Zillner, Munchen (DE); Claudia Bretschneider, Munchen (DE); Heiner Oberkampf, Munchen (DE)

(72) Inventors: Sonja Zillner, Munchen (DE); Claudia Bretschneider, Munchen (DE); Heiner Oberkampf, Munchen (DE)

(21) Appl. No.: 14/038,927

(22) Filed: Sep. 27, 2013

(51) Int. Cl. G06F 17/27

(52) U.S. Cl. CPC G06F 17/2785; G06F 17/2735
USPC 704/9

(57) ABSTRACT

Concept labels of an ontology are extended. An ontology includes concepts at least partially authored in a source language; a corpus at least partially authored in a target language is provided; said corpus is processed by a linguistical analysis and receiving a list of first terms as a result of said linguistical analysis, said first terms in said list ordered by a linguistical relevancy; within said list, at least one of said first terms is associated with an associated second term, said second term being a translation of said first term into said source language; a retrieval is conducted by using at least one of said second terms for identifying a matching concept within said ontology; and a concept label of said matching concept is extended by a first term associated to said second term of a matching retrieval.

### TECHNICAL FIELD

The present embodiments relate to a method for extending concept labels of an ontology. More specifically, the present embodiments relate to a method for extending concept labels of an ontology by labels authored in a target language.

### BACKGROUND

An ontology is understood as a formal specification of terminology and concepts, as well as the relationships among those concepts, relevant to a particular domain or area of interest. Ontologies provide insight into the nature of information particular to a given field and are essential to any attempts to arrive at a shared understanding of the relevant concepts. They may be specified at various levels of complexity and formality depending on the domain and information needs of the participants in a given conversation. Ontologies are used for various applications such as data standardization, integration, and many knowledge based systems.

Ontologies represent the vocabulary of a defined domain and serve as a common language for domain experts. Natural language processing or NLP-based applications using ontologies for recognizing listed concepts enable intelligent data access, retrieval, and analysis.

In the field of information extraction, which is a subtask of NLP, ontologies are used to recognize relevant domain concepts in unstructured resources. These extracted concepts are applied in subsequent processing acts, such as efficiently accessing content of the text.

### SUMMARY

Engineering of ontologies, however, is tedious. Defining relevant concepts and relations between concepts requires domain experts to be involved in this engineering.

Creating medical ontologies for instance, such as RadLex or FMA, experts of a correlating domain have to be involved in a complex and time-consuming process. It is, therefore, a common practice to use and amend existing ontologies.

A majority of currently existing ontologies are developed with concept labels that are authored exclusively in the English language—or source language hereinafter. This means that concept labels authored in a language other than English—a language other than English is hereinafter referred to as target language—are rare or not existent. Even though the structure of these ontologies may be well designed, a translation process is required in order to support a target language or even multilingualism. Without ontology concept labels in a required target language, the usage of ontologies in NLP based applications for texts authored in the target language is not effective.

Currently known approaches require extensive manual work in order to extend ontologies by translated concept labels, which means that an entire translation of all concept labels is not feasible. On the other hand, many application scenarios, like text annotation, require only a subset of ontology concepts relevant for a given context.

Since the ontology itself does not provide any information on the usage of individual concepts in a text to be annotated, it is not easy to define a starting point for an efficient extension of the ontology by concept labels authored in the target language.

Accordingly, there is a need in the art for providing an efficient extension of concept labels by labels in a target language in order to increase a concept coverage for a given corpus of texts.

Systems and methods in accordance with various embodiments provide for a method for extending concept labels of an ontology.

In one embodiment, a method for extending concept labels of an ontology is disclosed, including the acts of:
providing an ontology, said ontology including concepts at least partially authored in a source language;
providing a corpus of machine-readable text at least partially authored in a target language, a domain of said corpus being at least similar to a domain of said ontology;
processing said corpus by a linguistical analysis and receiving a list of first terms as a result of said linguistical analysis, said first terms in said list ordered by a linguistical relevancy;
associating, within said list, at least one of said first terms by an associated second term, said second term being a translation of said first term into said source language;
conducting a retrieval by using at least one of said second terms for identifying a matching concept within said ontology; and
extending a concept label of said matching concept by a first term associated to said second term of the matching retrieval.

In an embodiment, a method for extending an ontology with concept labels at least partially including terms in said target language is disclosed, including the act of associating at least one of said first terms by target-language vocabulary stems of said ontology.

According to an embodiment, a computer program product is disclosed. The computer program product is a non-transitory computer readable storage medium that includes instructions. The instructions are used by a programmed processor.

### BRIEF DESCRIPTION OF THE DRAWING

These and other objects and advantages of the present invention will become more apparent and readily appreciated from the following description of the preferred embodiments, taken in conjunction with the accompanying drawing of which:

FIG. 1 shows a flowchart of acts for extending concept labels of an ontology according to an embodiment;

FIG. 2 shows a flowchart of acts for translating terms into a source language according to an embodiment;

FIG. 3 shows a flowchart of acts for extending concept labels of an ontology by terms in a target language according to an embodiment; and;

FIG. 4 shows a flowchart of acts for extracting terms of a corpus according to an embodiment;

### DETAILED DESCRIPTION

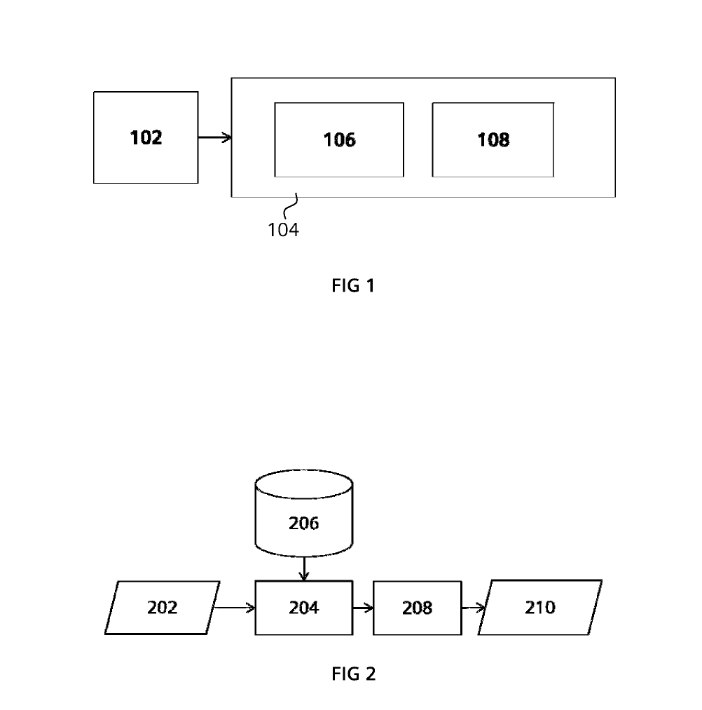

In FIG. 1, a flowchart of acts for extending concept labels of an ontology according to an embodiment is depicted.

The proposed method includes two major acts. In a first act 102, terms in a target language are extracted from a representative corpus, i.e. a large set of domain-specific text. In a second act 104, concept labels of an ontology are extended by at least some of said terms in the target language.

The act 104 of extending the concept labels encompasses an act 106 of translating the terms authored in a target language into a source language and a act 108 of mapping terms in source language to existing ontology concepts in order to eventually extend concept labels of the ontology by terms in the target language.

The embodiment supports a universal, language-independent translation process for ontologies from any given source language to any target language, e.g. extending concept labels of medical ontologies from labels in English language being the source language by labels in German language being the target language. Although the concept labels are extended by this embodiment, concepts as well as relations between concepts remain as they are.

The proposed method relies on the assumption that any ontology can be extended by using a corpus, i.e. a set of representative texts, whereby the domain of said corpus is equal or at least similar to the domain of the ontology.

A vocabulary of the ontology is assumed to cover the most relevant concepts of the domain. As any domain-specific corpus also contains said relevant concepts, the corpus is treated as a reference of which concepts are important to translate. For extending an exemplary ontology known as RadLex with its vocabulary representing general concepts of a medical radiology domain, a corpus of radiology reports is advantageously used in order to determine the most relevant concepts for translation.

Furthermore, in order to efficiently extend ontologies using this corpus-based approach, human interaction is to be reduced to a minimum. Hereinafter, an efficient extension is to be understood as translating most relevant concept labels in order to increase the concept recognition within the corpus by least or no human interaction other than initiation.

Accordingly, a linguistical analysis using statistical methods is used for rating a linguistical relevancy of terms within the target language vocabulary, e.g. according to an occurrence frequencies of terms within the corpus. In other words, frequently occurring terms within the corpus are paramount for an extension of the ontology.

Processing the corpus by the linguistical analysis results in a list of terms in which the terms are ordered by a linguistical relevancy. These terms are in the language of the corpus, which is the target language. Hereinafter, these terms in target language are referred to as >>first terms<< in order to distinguish a first term from respective a second term, the second term being a translation into source language of the first term.

In the following, the act 102 of extracting terms in a target language from a representative corpus is detailed by FIG. 4.

In act 406, a language analysis is performed. The act 406 of language analysis uses two basic input resources, a representative, machine readable corpus 402, authored in target language, and an ontology 404 including vocabulary in the source language. The domain of the corpus 402 is identical or at least similar to the domain of the ontology 404.

In act 406, in conjunction with a statistical analysis, which is either provided consecutively or in parallel by act 408, the corpus 402 is processed by a linguistical analysis. The linguistical analysis is e.g. based on natural language processing, or NLP, techniques aiming to extract terms exhibiting a linguistical relevancy. This linguistical relevancy may be defined by a frequency of occurrence, a number of occurrences, or a linguistical weight of the terms within the corpus.

After optionally processing in act 410 applying a filtering algorithm, a list of first terms 412 as a result of the linguistical analysis is provided, the first terms in the list ranked by their linguistical relevancy. The list of first terms authored in target language is used for translation and ontology concept extension by respective subsequent acts disclosed hereinafter.

Generally, a term refers to a lexical item that occurs in a collection which optionally includes phrases. Accordingly a term subsumes two types, single words or multi-word phrases, also referred to as n-grams. Embodiments include a translation of both types of terms.

An embodiment of the linguistical analysis includes the following acts:

In a first act, the corpus is processed using linguistical techniques tailored for the domain-specific language. This includes particularly the determination of the basic processing units words and sentences. Furthermore, the individual words are stemmed for the subsequent annotation task. A stem is to be understood as the smallest word unit supplying the main meaning, whereas generally any possible affixes are removed. The word >>re-adjust-ment<< for instance is stemmed to >>adjust<<. According to an embodiment, a stemming algorithm removing only suffixes is used so that the words >>mediastinal<< and >>Mediastin-um<< are mapped to the same stem >>mediastin<<. This common stem is a single word term in the list of translated concepts.

According to a second act, the list of stems resulting from the previous act is used for the creation of a list of first terms, which is to be translated. Statistical techniques are used to evaluate the text stems according to their occurrence and/or co-occurrence. The act outputs a list that includes both types of terms: single words and n-grams. Statistical measures are computed for each single word stem e.g. an occurrence count, showing a degree of how often a particular stem occurs within the corpus. At the same time, any combination of stems or n-grams occurring or co-occurring in the same sentence is evaluated as terms. For each n-gram a co-occurrence count is computed, showing a degree of how often a particular combination of stems co-occurs within the sentence boundary.

A respective (co-)occurrence count of each particular term is used for a subsequent ranking of terms in a list wherein each ordered by a linguistical relevancy, whereas the most frequent occurring term is rated top. The result of this task is a list of terms ordered by linguistical relevancy, here: occurrence and/or co-occurrence, including respective statistical measures assigned to each term.

According to an embodiment a subsequent act 410 is provided, the act 410 applying a filtering algorithm. This act 410 aims to limit the number of first terms which are to be translated into source language with the outcome of a list wherein at least one of said first terms is associated by a second term, said second term being a translation of said first term into said source language.

This act 410 is application-specific and may employ three kinds of information in order to exclude terms from translation:
Linguistical information, i.e. linguistical knowledge gained from the initial linguistical analysis is of possible importance for the exclusion of terms from translation. The basic assumption is that only terms important for the domain should be translated. For example no domain-specific ontology should contain concepts without domain specific semantics such as the following bi-gram: >>besides the<<, wherein >>besides<< is a preposition and >>the<< is an article.
Statistical information: For example only terms found in a certain percentage of the texts or which occur at least 100 times should be further processed. Thus, the filtering algorithm takes the (co-)occurrence count thresholds into account.
Any additional information: Any other information from external sources could be also of importance to gain insight on the importance of a term for the domain. As in general, only terms with domain importance should be translated. If an external source disproves this importance, the term is excluded from the translation suggestion list.

The outcome of the flowchart of acts shown in FIG. 4 is a list of first terms 412 as a result of the linguistical analysis and an optionally act of filtering. By referring back to FIG. 1, the act 102 of extracting terms from a representative corpus is concluded.

The proposed method does not rely on simply translating given ontology concepts to the desired target language, but uses a corpus in order to identify relevant concepts. However, in order to ensure that only existing ontology concepts are extended with additional labels, the acts 106 of translating the terms authored in a target language into a source language and the act 108 of mapping terms in source language to existing ontology concepts are provided in order to eventually extend concept labels of the ontology by terms in the target language by act 104.

This act 104 uses the ranked list of first terms from the corpus by mapping the respective second terms to existing ontology concepts. The sub-act 106 of translating each first term into a respective second term in source language is supporting a retrieval of a correct mapping ontology concept already available in source language.

Under the assumption that ontology concepts have labels in the given source language, like e.g. English, the task of retrieving is to identify an ontology concept for the term from the text corpus. This task involves two sub acts:
Act 106: The identified first term in target language is translated into an associated second term in source language in order to retrieve a matching concept, which corresponding concept label is, eventually, extended by the first term associated to the second term;
Act 108: the second terms are used to find correlating ontology concepts.

The act 106 shown in FIG. 1 is detailed by FIG. 2 which shows a flowchart of acts for translating terms into the source language.

An ordered list 202 which is the outcome of the preceding acts includes a plurality of first terms. Each of these first terms is to be associated by a second term, said second term being a translation of said first term into said source language.

First terms included in the ordered list 202 will be used as queries to a translation module 206, which is optionally provided by a translation service. While the query contains first terms, the resulting set contains matching second terms in source language.

A human user feedback is optionally provided in act 208 in order to increase the quality or relevancy of the second term and, consequently, the ontology extensions to be provided for the ontology. The act 208 of human user feedback provides a selection of a correct second term for the case that the translation module 206 has provided a plurality of possible translations, thereby disambiguating the second term. In cases where the first term has a second meaning in general language in parallel to the meaning of the first term in the desired domain-specific language, the translation proposed by the translation module 206 is likely to be wrong. The act 208 of human user feedback ensures in such cases that the erroneous translation is amended by a correct domain-specific translation.

As a result, an ordered list 210 of first terms associated by a respective second term is provided.

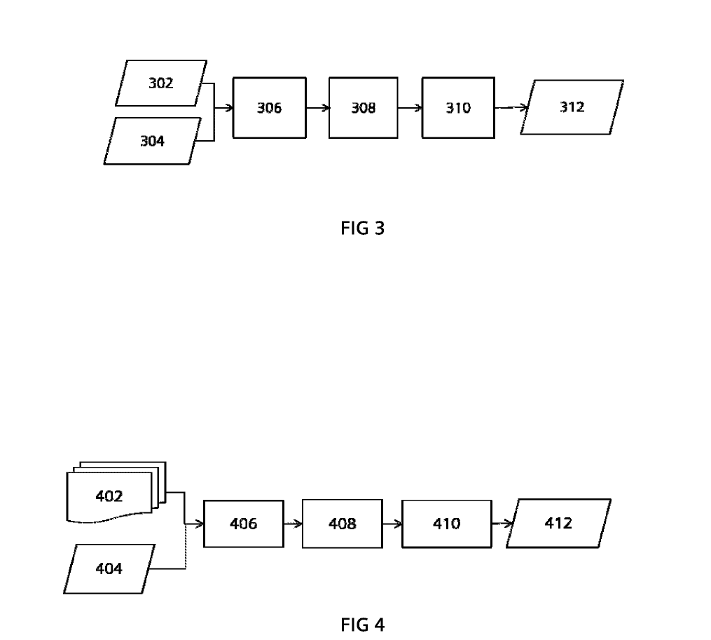

FIG. 3 shows a flowchart of acts for extending concept labels of an ontology by terms in the target language.

An ontology 302 for which concepts are to be extended by labels in the target language and the ordered list 304 from the preceding acts is input to an act 406 providing an ontology matching. The act 406 is providing a retrieval by using at least one of the second terms of the ordered list for identifying a matching concept within said ontology. In other words, a second term in source language is used to retrieve a matching ontology concept, authored in source language.

An act 408 provides a manual user feedback in order to increase the quality of mapping.

Eventually, in act 410, matching ontology concepts are extended by the first term in order to include the target language variants in the extended ontology 412.

The disclosure so far assumed an input ontology, which previously does not include any concept labels authored in the target language. Some ontologies, however, already include sparse concept labels in the target language which can nevertheless be utilized for expediting the process of extending concept labels.

Hereinafter, an embodiment of the proposed method is disclosed, using an ontology in which concept labels are partially populated with terms in the target language.

It is, however, assumed that the amount of vocabulary available in source language exceeds the amount of vocabulary in the target language by far. Accordingly, the object of extending the concept labels of such an ontology persists.

Referring again to FIG. 4, a language analysis by act 406 in conjunction with a statistical analysis by act 408 is performed. Act 408 is either provided consecutively or in parallel with act 408. Both acts are contributing to a linguistical analysis.

According to an embodiment of the linguistical analysis, using an ontology in which concept labels are partially populated with terms in the target language, the following acts are included:

In a first act, the corpus is processed using linguistical techniques tailored for the domain-specific language as disclosed below.

After this first act, a subsequent act—not shown in the drawing—of executing an ontology-based concept annotation is carried out which is specific to the embodiment using an ontology in which concept labels are partially populated with terms in the target language. This act is interposed between act 406 and act 408 in order to take advantage of already available but limited concept labels in target language. By said act a concept mapping combines target-language vocabulary stems from the ontology and stems from the corpus and retrieves matches for the listed ontology concepts. Each of the matching stems is annotated with the represented ontology concepts. In the ordered list, a respective first term is associated by target-language vocabulary stems of the ontology.

Subsequently the second act described below is executed in which the list of stems resulting from the previous act is used for the creation of a list of first terms, which is to be translated. Statistical techniques are used to evaluate the text stems according to their occurrence and/or co-occurrence. The act outputs a list that includes both types of terms: single words and n-grams.

The following statistical measures are computed for each single word stem:
An occurrence count, showing a degree of how often a particular stem occurs within the corpus;
An appendix for a term consisting of an annotation list, i.e. a list of ontology concepts determining which annotations have been assigned to the stem, an information of whether annotations are available for the stem and an information of how often the stem is annotated or, alternatively, how often the stem could not be annotated.

At the same time, any combination of stems or n-grams occurring or co-occurring in the same sentence is evaluated as terms.

The following statistical measures are computed for each single n-gram:
A co-occurrence count, showing a degree of how often a particular combination of stems co-occurs within a sentence boundary;
An appendix for a term consisting of an annotation list, i.e. a list of words determining which annotations have been assigned to the stem, an information of whether annotations are available for the stem and an information of how often the stem is annotated or, alternatively, how often the stem could not be annotated.

A respective (co-)occurrence count of each particular term is used for a subsequent ranking of terms in a list wherein each ordered by a linguistical relevancy, whereas the most frequent occurring term is rated top. The result of this task is a list of terms ordered by linguistical relevancy, here: and/or co-occurrence, including respective statistical measures assigned to each term.

According to an embodiment, a subsequent act 410 is provided, the act 410 of applying a filtering algorithm.

This act 410 is application-specific and may employ three kinds of information in order to exclude terms from translation:

In addition to the aforementioned catalogue consisting of linguistical information, statistical information and additional information, additional annotation information is employed in order to exclude terms from translation. Said annotation information includes information available by an ontology, in which concept labels are partially populated with terms in the target language. The terms in the target language are also taken into account for filtering. To name one example, the filtering algorithm excludes terms, which are already represented in the existing ontology concepts of interest. In other words, there is no reason to include any term in the translation suggestions of an ordered list which is already annotated by an existing concept in the target language.

The outcome of the flowchart of acts shown in FIG. 4 is a list of first terms 412 as a result of the linguistical analysis and an optionally the act of filtering. By referring back to FIG. 1, the act 102 of extracting terms from a representative corpus is concluded.

Hereinafter, an extension of concept labels of a medical ontology captioned RadLex according to the proposed method is illustrated by way of an example. RadLex serves as an example for an ontology authored in English language which is the source language. The concept of RadLex labels are partially populated with terms in German language. German is assumed as being the target language for the exemplary task of providing a usage of RadLex in a German context.

In order to extend the partially translated RadLex ontology, the RadLex ontology 404 itself and German radiology reports being a corpus 402 representing the ontology domain are input in a process according to a flow chart depicted by FIG. 4.

First, the sentence and word boundaries are detected. Each word is stemmed with a specially tailored stemming algorithm that considers both, the German language particularities and the medical language specifics in the language.

Second, the same stemming algorithm is applied in the subsequent annotation task to the already existing German ontology concepts. The radiology reports are annotated with these RadLex concepts.

Third, the resulting stem-annotation occurrences are statistically analyzed. The resulting ordered list of first terms as a result of the linguistical analysis is depicted below:

| 1 | 2 | 3 | 4 | 5 |
|---|---|---|---|---|
| Lymfknot | 6144 | RID455- | 6144 | 0 |
| | | Pericolischer | | |
| | | Lymfknoten | | |
| | | RID1509- | | |
| | | Segmentaler | | |
| | | Lymfknoten | | |
| | | . . . | | |

. . .

| | | | | |
|---|---|---|---|---|
| unveraendert | 3382 | RID5734- | 3382 | 0 |
| | | unverändert | | |

. . .

| | | | | |
|---|---|---|---|---|
| rechts | 2878 | RID4972-right- | 22 | 2856 |
| | | to-left shunt | | |

. . .

Wherein, in said ordered list:
column 1 (captioned >>1<< in the column head of the column shown above) provides the first term;
column 2 (captioned >>2<< in the column head of the column shown above) provides an integer of the (co-) occurrence count;
column 3 (captioned >>3<< in the column head of the column shown above) provides annotated concepts;
column 4 (captioned >>4<< in the column head of the column shown above) provides an integer of the number of terms annotated;
column 5 (captioned >>5<< in the column head of the column shown above) provides an integer of the number of terms not annotated;

The first terms in the ordered list are ranked by their linguistical relevancy.

A high occurrence of the stem >>Lymfknot<< deducted by the word >>Lymphknoten<< (which is >>lymph node<< in English) and the stem >>unveraendert<< (deducted by the word unverändert) is present in the corpus.

The term >>unveraendert<< is fully annotated as it occurs 3382 times and is annotated 3382 times. The term >>Lymfknot<< is fully annotated as it occurs 6144 times and is annotated 6144 times.

A filtering algorithm is applied consequently aiming to remove terms which are not required for a translation.

The term >>unveraendert<< can be removed, because all occurrences have been annotated, i.e. their respective number of occurrence count is identical with the number of terms annotated. As >>unveraendert<< is already fully annotated, there is no need to add this translation to the RadLex ontology.

The term >>Lymfknot<< can be removed, because all of their occurrences have been annotated, i.e. their respective umber of occurrence count is identical with the number of terms annotated.

That means, the translation available in the ontology is sufficient to cover the terms in the texts and there is no need to translate and integrate another translation these terms into the ontology.

For adding the partially missing target language label >>rechts<< to the ontology, it is necessary to find the correct existing ontology concept to add this label to. As the existing concepts only contain English concept labels, the German label has to be translated back to English. The translation act will deliver lymph node as a translation suggestion.

The reduced list of terms to be translated is input to the translation module 206 integrating online available repositories like DBpedia or dictionary services for the translation. The list of German terms extracted from the radiology reports is used to query the linked translation services. The services return translations for the given terms in English language, e.g. >>rechts<< is translated as >>right<<.

The results of the translation task are reviewed by physicians, who are the respective experts of this medical domain. Based on their feedback, the translation is accepted or a corrected translation of the term is amended for the subsequent processing act.

Eventually, in act 410, matching ontology concepts are extended by the first term in order to include the target language variants in the extended ontology 412. In act 410, English translations of the German terms are used to retrieve the correlating, existing English ontology concept in RadLex. The English term >>right<< is found as RadLex concept with unique identifier RID5825. The physician accepts this proposal as the correct choice. Finally, the German term >>rechts<< is added as additional concept label translation to the RadLex ontology.

The proposed method advantageously operates application-driven. For translating a given corpus, the scope of translations is defined by the boundaries of the domain defined by the corpus itself. At the same time, the corpus represents the same domain as the ontology to be translated and can be regarded as optimal basis to infer the most relevant concepts for the translation. After translation, the subsequent processing acts relying on the translated vocabulary can achieve the best possible outcome, since the translation is specially tailored to this domain. But this tailoring is advantageously only determined by the input resources, not the process chain itself.

The proposed method advantageously does not aim a translation of all concepts, but a focused set of concepts with the best quality possible. A set of relevance criteria, which are defined by the application, weights the possible translation concepts, ranks the most relevant concepts and inputs these into the ontology translation acts. The relevance is based on a representative corpus. This corpus is the most reliable source for this task, as it represents real world information which the ontology has to represent. Accordingly, not all concepts of the ontology need to be extended by labels in the target language. Rather, only concepts with relevance for the application specific text corpus need to be extended.

The proposed method advantageously expedites the translation of concepts. First, the translation is based on a corpus, not on the ontology itself. The target language is the starting point for the translation, not the source language. Second, the proposed method includes an approach for choosing the most relevant concepts for translation by introducing a linguistical relevancy. Third, within the act of matching the target language concept into existing concepts of the ontology, the translation of concepts is actually carried out by a reverse translation to source language.

Embodiments of the invention can be implemented in computing hardware (computing apparatus with a processor) and/or software, including but not limited to any computer that can store, retrieve, process and/or output data and/or communicate with other computers.

The processes can also be distributed via, for example, downloading over a network such as the Internet. The results produced can be output to a display device, printer, readily accessible memory or another computer on a network. A program/software implementing the embodiments may be recorded on computer-readable media comprising computer-readable recording media.

The program/software implementing the embodiments may also be transmitted over a transmission communication media such as a carrier wave.

Examples of the computer-readable recording media include a magnetic recording apparatus, an optical disk, a magneto-optical disk, and/or a semiconductor memory (for example, RAM, ROM, etc.). Examples of the magnetic recording apparatus include a hard disk device (HDD), a flexible disk (FD), and a magnetic tape (MT).

Examples of the optical disk include a DVD (Digital Versatile Disc), a DVD-RAM, a CD-ROM (Compact Disc-Read Only Memory), and a CD-R (Recordable)/RW.

The invention has been described in detail with particular reference to preferred embodiments thereof and examples, but it will be understood that variations and modifications can be effected within the spirit and scope of the invention covered by the claims.

What is claimed is:

1. A method for extending concept labels of an ontology, the method comprising:
providing, in a memory, an ontology, said ontology including concepts at least partially authored in a source language;
providing, in the memory, a corpus of machine-readable text at least partially authored in a target language, a domain of said corpus being at least similar to a domain of said ontology;
processing, by a processor, said corpus by a linguistical analysis and receiving a list of first terms as a result of said linguistical analysis, said first terms in said list ordered by a linguistical relevancy;
associating, within said list, at least one of said first terms by an associated second term, said second term being a translation of said first term into said source language;
conducting, by the processor, a retrieval by using at least one of said second terms for identifying a matching concept within said ontology; and;
extending, by the processor, a concept label of said matching concept by a first term associated to said second term of a matching retrieval.

2. The method according to claim 1, wherein said linguistical relevancy is a frequency of occurrence, a frequency of co-occurrence, a number of occurrences, a number of co-occurrences, or a linguistical weight.

3. The method according to claim 1, wherein the ontology has with concept labels at least partially including terms in said target language, the method further comprising:
associating, within said list, at least one of said first terms by target-language vocabulary stems of said ontology.

4. A computer program product comprising program code stored on a non-transitory computer-readable medium and which, when executed on a computer, is configured to:
provide an ontology, said ontology including concepts at least partially authored in a source language;
provide a corpus of machine-readable text at least partially authored in a target language, a domain of said corpus being at least similar to a domain of said ontology;
process said corpus by a linguistical analysis and receive a list of first terms as a result of said linguistical analysis, said first terms in said list ordered by a linguistical relevancy;
associate, within said list, at least one of said first terms by an associated second term, said second term being a translation of said first term into said source language;
conduct a retrieval by using at least one of said second terms for identifying a matching concept within said ontology; and;
extend a concept label of said matching concept by a first term associated to said second term of a matching retrieval.

5. The computer program product according to claim 4, wherein said linguistical relevancy is a frequency of occurrence, a frequency of co-occurrence, a number of occurrences, a number of co-occurrences, or a linguistical weight.

6. The computer program product according to claim 4, wherein the ontology has with concept labels at least partially including terms in said target language, the computer further configured to:
associating, within said list, at least one of said first terms by target-language vocabulary stems of said ontology.
